(19) United States
(12) Patent Application Publication
(10) Pub. No.: US 2007/0084948 A1
(43) Pub. Date: Apr. 19, 2007

(54) Spray gun

(76) Inventor: Chih-Chang Chen, Taichung City (TW)

Correspondence Address: CHARLES E. BAXLEY, ESQ., 90 JOHN STREET, THIRD FLOOR, NEW YORK, NY, 10038, US

(21) Appl. No.: 11/253,951

(22) Filed: Oct. 18, 2005

(51) Int. Cl. B05B 1/28

(52) U.S. Cl. 239/290; 239/302

(57) ABSTRACT

The present invention relates to a spray gun that comprises an inlet formed at an end thereof for introduction of compressed air and a spout for spraying paint. The spray gun is made of Polyphenylene Sulfide. The forming process of Polyphenylene Sulfide is similar to the common plastic so that the spray gun can be made by ejection molding. Therefore, the spray gun is not only low cost and light weight but also has high resistance to chemical erosion, high temperature and impact.

### BACKGROUND OF THE INVENTION

1. Field of the Invention The present invention relates to a spray gun, and more particularly to a spray gun that made of Polyphenylene Sulfide.

2. Description of the Prior Art

Referring to FIG. 1, a conventional spray gun 10 that is used for coating operation and comprises an inlet 12 for introduction of compressed air into the spray gun, a feeding container 11 for containing coating material, and a spout 13 for spraying coating material, so that the coating material can be sprayed out by pressing the trigger.

The paint is often mixed with toluene, turpentine and the air pressure is quite high, therefore, the spray gun should be made of material having high strength and high resistance to chemical erosion, such as aluminum alloy, alloy, cast iron etc.

Please notice that the spray gun made of metal material has the problems of complicated forming process, heavy weight, low resistance to fall and high cost.

The present invention has arisen to mitigate and/or obviate the afore-described disadvantages.

### SUMMARY OF THE INVENTION

The primary objective of the present invention is to provide a spray gun made of Polyphenylene Sulfide, it is not only low cost and light weight but also has high resistance to chemical erosion, high temperature and impact.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of showing a conventional spray gun structure;

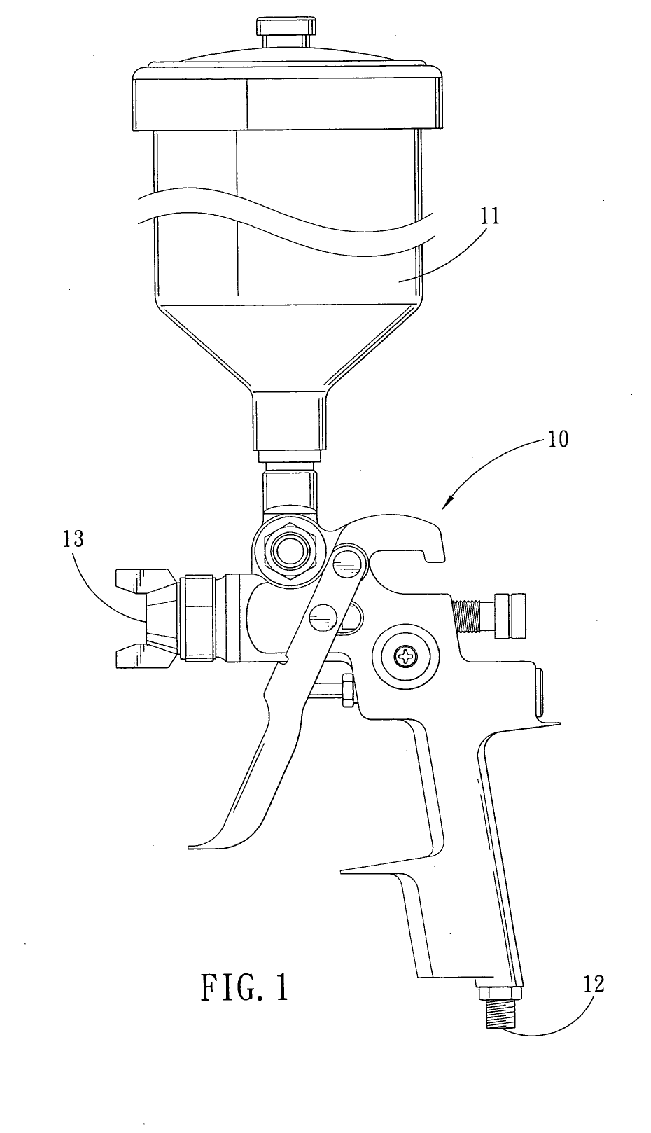

FIG. 2 is a cross sectional view of showing a body of a spray gun in accordance with the main body of the present invention;

FIG. 3 is a perspective view of the spray gun in accordance with the present invention.

### DETAILED DESCRIPTION OF THE PREFERRED EMBODIMENT

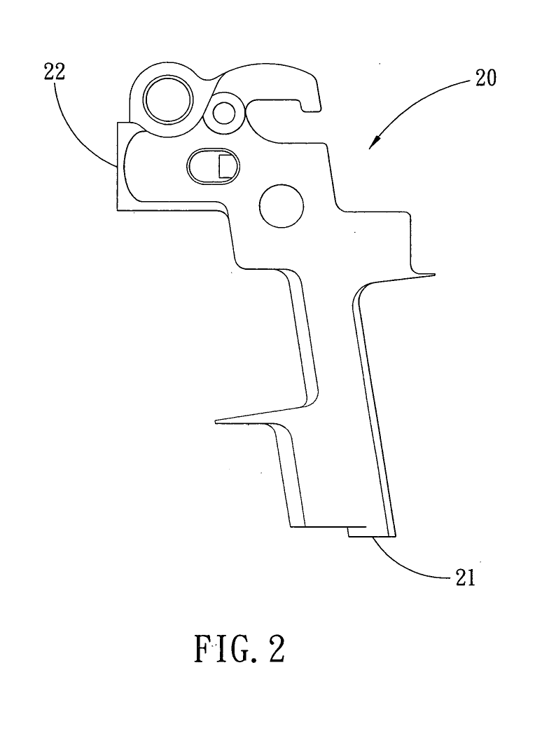

Referring to FIG. 2, a spray gun in accordance with the present invention is made of Polyphenylene Sulfide (PPS). The PPS is a high insulation thermoplastic that is light weight (60% lighter than the ordinary metal material) and has high temperature resistance over 150° C., and high resistance to chemical erosion

A body 20 of the spray gun comprises an inlet 21 formed at an end thereof for introduction of compressed air into the spray gun and a spout 22 formed at another end for spraying coating material. The spray gun 20 is made of PPS, and the forming process of PPS is similar to that of the ordinary plastic, so that the spray gun 20 can be made easily by ejection molding, and accordingly the production cost is reduced substantially

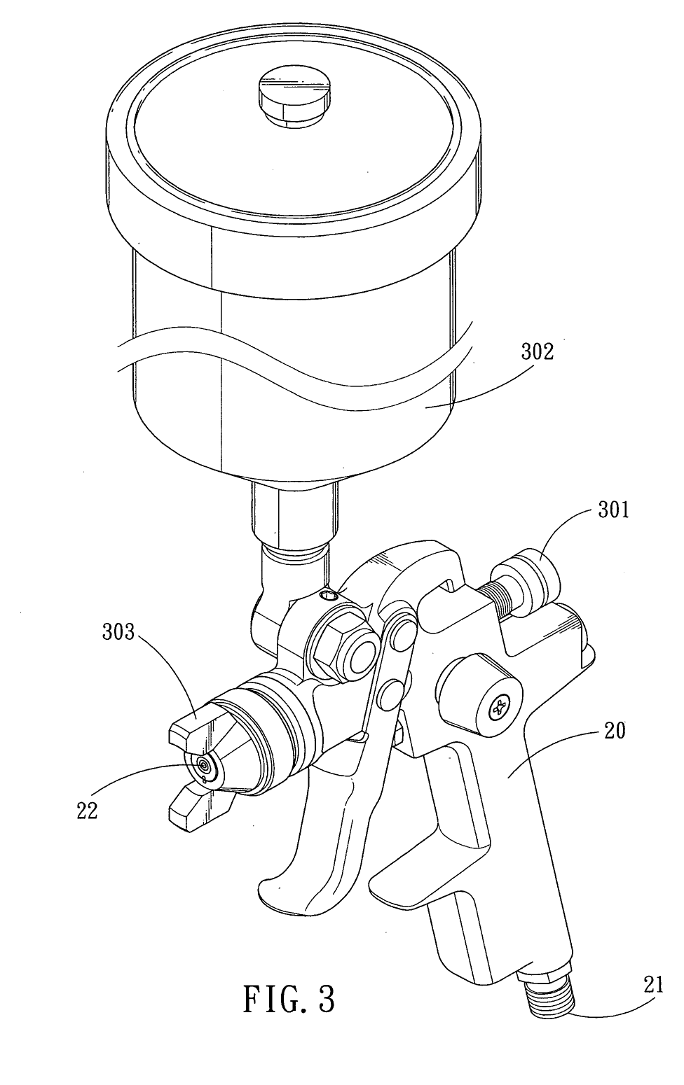

After forming the body 20 of the spray gun, other fittings: such as adjusting button 301, coating material container 302, nozzle 303 can be assembled to the body 20 (as shown in FIG. 3). Since the PPS has flexibility property, the fittings can be assembled with the body 20 more tightly.

As compared to the metal spray gun, the spray gun made of PPS is 60% lighter, and can be operated more conveniently. Furthermore, the spray gun 20 has high resistance to chemical erosion even if the users clean it by solvent and is not easy to break up even if dropping from high places.

While we have shown and described various embodiments in accordance with the present invention, it should be clear to those skilled in the art that further embodiments may be made without departing from the scope of the present invention.

What is claimed is:

1. A spray gun comprising an inlet formed at an end thereof for introduction of compressed air and a spout formed at another end thereof for spraying coating material, wherein the spray gun is made of Polyphenylene Sulfide.

2. The spray gun as claimed in claim 1, wherein the spray gun is made by ejection molding.
